(19) United States
(12) Patent Application Publication
(10) Pub. No.: US 2009/0251287 A1
(43) Pub. Date: Oct. 8, 2009

(54) Electronic vehicle license and a reading and writing control device therefor

(76) Inventor: Chih-Cheng Lin, Sinhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,882

(22) Filed: Apr. 8, 2008

(51) Int. Cl. H04B 7/00

(52) U.S. Cl. 340/10.1

(57) ABSTRACT

An electronic vehicle license is installed on a vehicle to store a record and insurance data of the vehicle, and a reading and writing control device is provided for an authority/official organization to read and write data into the electronic vehicle license; the electronic vehicle license includes a storage unit, a non-contact transferring unit, and a central processing unit; the reading and writing control device includes a central controlling unit, which has a weight assigned thereto in accordance with a jurisdiction of the authority that is authorized to use the reading and writing control device so that the central controlling unit is allowed to handle certain categories of data; the reading and writing control device further includes an encrypting and decrypting unit, a non-contact transferring unit, and a displaying unit to show the data of the vehicle license.

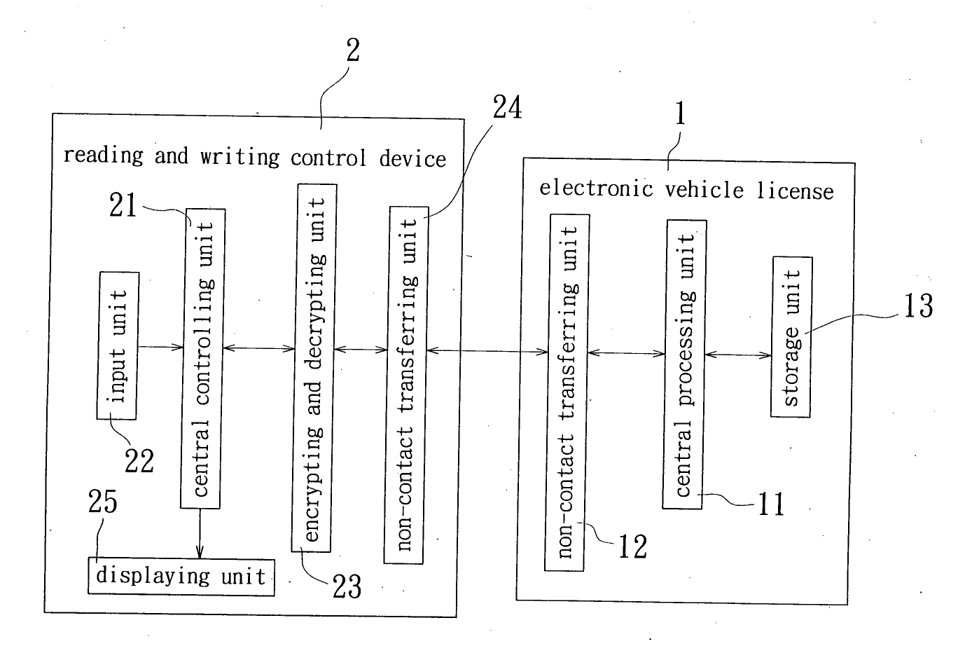

### BACKGROUND OF THE INVENTION

1. Field of the invention

The present invention relates to an electronic vehicle license and a reading and writing control device for use with the electronic vehicle license, more particularly ones, which are installed on a vehicle, and provided for use by the authority respectively, and which can secure the record and insurance data of the vehicle from unauthorized persons, and help the authority manage and check the vehicle record.

2. Brief Description of the Prior Art

The task of managing vehicles is becoming more difficult for the authority/official departments because of the ever-increasing number of vehicles, especially automobiles and motorcycles.

Each vehicle has its own record, which includes engine number, license plate number, horse power value, manufactured date, name and address of the owner, and insurance data. Vehicle records are put in a file kept in the vehicle and driver supervision and management organization as well as the insurance company, and they are put in the vehicle licenses and insurance cards to be carried by the owners/drivers of the vehicles. The drivers have to carry vehicle licenses and insurance cards according to the provision, yet they can forget to carry the licenses and insurance cards because the licenses and insurance cards are separate from the vehicles. Furthermore, the authority/insurance companies have to change the licenses or insurance cards for the drivers if data change. Therefore, the conventional vehicle licenses and insurance cards are neither convenient nor economical to use.

### SUMMARY OF THE INVENTION

It is a main object of the present invention to provide an electronic vehicle license and a reading and writing control device for use with the electronic vehicle license to overcome the above problems.

An electronic vehicle license according to an embodiment of the present invention includes a storage unit, a non-contact transferring unit, and a central processing unit while a reading and writing control device includes a central controlling unit, an encrypting and decrypting unit, a non-contact transferring unit, and a displaying unit. The electronic vehicle license is installed on a vehicle to store a record and insurance data of the vehicle. The reading and writing control device is provided for the authority/official organization to read and write data into the electronic vehicle license. The central controlling unit of the reading and writing control device has a weight assigned thereto in accordance with a jurisdiction of the authority that is authorized to use the reading and writing control device; thus, the central controlling unit is only allowed to handle certain categories of data. Therefore, vehicle records and insurance data can be secured from unauthorized persons, and easily managed and checked by the authority/official organization.

### BRIEF DESCRIPTION OF THE DRAWINGS

The present invention will be better understood by referring to the accompanying drawings, wherein:

The FIGURE is a block diagram of an electronic vehicle license and a reading and writing control device according to the present invention.

### DETAILED DESCRIPTION OF THE PREFERRED EMBODIMENTS

Referring to the FIGURE an electronic vehicle license 1 and a reading and writing control device 2 in accordance with the present invention are provided. The electronic vehicle license 1 is installed on a predetermined place on a vehicle. Such reading and writing control devices 2 are provided to various organizations and government departments such as police departments, vehicle and driver supervision and management organizations, and insurance companies.

The electronic vehicle license 1 is a chip, and includes a central processing unit 11, a non-contact transferring unit 12, and a storage unit 13. The storage unit 13 is used to store data of a vehicle, which include a record and insurances of the vehicle. The non-contact transferring unit 12 is used to transfer data from and into the storage unit 13. When data of the vehicle is being transferred into the electronic vehicle license 1, the central processing unit 11 will give a weight to each of the data according to the sorts of the data, and input the data into the storage unit 13. The central processing unit 11 can pick data from the storage unit 13; the non-contact transferring unit 12 will transfer the data to the reading and writing control device 2 immediately after the central processing unit 11 picks data from the storage unit 13.

The reading and writing control device 2 includes a central controlling unit 21, an input unit 22, an encrypting and decrypting unit 23, a non-contact transferring unit 24, and a displaying unit 25. The central controlling unit 2 has a weight assigned thereto in accordance with the rank and jurisdiction of an authority/official organization that is authorized to use the reading and writing control device 2; thus, the central controlling unit 21 is allowed to handle data within certain limits; for example, the central controlling unit 21 is only allowed to handle vehicle records or insurance data. The input unit 22 can be used to input data into the central processing unit 21. The encrypting and decrypting unit 23 is used to encrypt data input through the input unit 21; data will be transferred to the electronic vehicle license 1 through the non-contact transferring unit 24 after being encrypted with the encrypting and decrypting unit 23. Furthermore, encrypted data in the electronic vehicle license 1 can be transferred to the reading and writing control device 2 through the non-contact transferring unit 24; the encrypting and decrypting unit 23 will decrypt the encrypted data transferred from the electronic vehicle license 1, and the displaying unit 25 will show the data immediately after the decryption.

Various technologies that use non-contact data transfer can be applied to the non-contact transferring units 12 and 24 of the electronic vehicle license 1 and the reading and writing control device 2, e.g. electromagnetic, magnetic reed, and microwave technologies.

When a factory finishes manufacturing a vehicle, the record, insurance and other data of the vehicle can be written in such an electronic vehicle license 1, and stored in the storage unit 13, and next the electronic vehicle license 1 is installed on a predetermined place of the vehicle. Afterwards, officials of the authority can read the data stored in the electronic vehicle license 1 with the help of the reading and writing control device 2.

When the reading and writing control device 2 is used to read the electronic vehicle license 1, the central controlling unit 21 will send out a signal through the non-contact transferring unit 24 according to its weight, which is assigned in accordance with the rank and jurisdiction of the authority to use the control device 2. Next, the electronic vehicle license 1 will receive the signal through the non-contact transferring unit 12, and the central processing unit 11 will pick corresponding data, e.g. record and insurance data of the vehicle, from the storage unit 13 accordingly. And, the data will be sent out through the non-contact transferring unit 12, received through the non-contact transferring unit 24 of the reading and writing control device 2, decrypted with the encrypting and decrypting unit 23, and shown on the displaying unit 25.

When the reading and writing control device 2 is used to write data such as records and insurance data of the vehicle into the electronic vehicle license 1, the electronic vehicle license 1 will only accept those data that match the reading and writing control device 2, which has a weight assigned thereto in accordance with the rank and jurisdiction of the official organization authorized to use the device 2; in other words, only those data that this particular official organization is authorized to handle can be written into the electronic vehicle license 1. In use, first, data are input into the reading and writing control device 2 through the input unit 22, and next the encrypting and decrypting unit 23 will encrypt the data, and the non-contact transferring unit 24 will send out the encrypted data. Finally, the data will be received with the non-contact transferring unit 12, and stored in the storage unit 13 of the electronic vehicle license 1.

From the above description, it can be seen that the present invention has the following advantages: with the electronic vehicle license and reading and writing control device of the present invention vehicle records and insurance data can be secured from unauthorized persons, and easily managed and checked by the authority/official organization.

What is claimed is:

1. An electronic vehicle license, comprising
a vehicle license chip, the vehicle license chip including:
a storage unit to store data of a vehicle, which include a record and insurances of the vehicle;
a non-contact transferring unit; and
a central processing unit; the central processing unit being capable of giving a weight to each of the data according to a rank of each of the data and input the data into the storage unit; the central processing unit being capable of picking data from the storage unit according to a picking instruction signal given thereto through the non-contact transferring unit; the central processing unit being going to output data through the non-contact transferring unit after picking data from the storage unit according to a picking instruction signal given thereto.

2. The electronic vehicle license as claimed in claim 1, wherein microwave technology is applied to the non-contact transferring unit.

3. The electronic vehicle license as claimed in claim 1, wherein electromagnetic technology is applied to the non-contact transferring unit.

4. The electronic vehicle license as claimed in claim 1, wherein magnetic reed technology is applied to the non-contact transferring unit.

5. A reading and writing control device for reading and writing data into the electronic vehicle license as claimed in claim 1, comprising
a central controlling unit; the central controlling unit having a weight assigned thereto in accordance with a jurisdiction of an authority that is authorized to use the reading and writing control device so that the central controlling unit is allowed to handle data within the jurisdiction;
an input unit; the input unit being capable of inputting data into the central processing unit;
an encrypting and decrypting unit; the encrypting and decrypting unit being capable of encrypting data input from the input unit; data being going to be transferred to the electronic vehicle license after being encrypted with the encrypting and decrypting unit;
a non-contact transferring unit; the non-contact transferring unit being capable of transferring encrypted data from the electronic vehicle license to the encrypting and decrypting unit so that the encrypting and decrypting unit can decrypt said encrypted data; and
a displaying unit to show data after the data are decrypted with the encrypting and decrypting unit.

6. The reading and writing control device as claimed in claim 5, wherein microwave technology is applied to the non-contact transferring unit.

7. The reading and writing control device as claimed in claim 5, wherein electromagnetic technology is applied to the non-contact transferring unit.

8. The reading and writing control device as claimed in claim 5, wherein magnetic reed technology is applied to the non-contact transferring unit.
